(19) United States
(12) Patent Application Publication
(10) Pub. No.: US 2007/0201742 A1
(43) Pub. Date: Aug. 30, 2007

(54) Camera with red-eye correction function

(75) Inventor: Masaki Hayashi, Chiba-shi (JP)

Correspondence Address: OLIFF & BERRIDGE, PLC, P.O. BOX 19928, ALEXANDRIA, VA, 22320, US

(73) Assignee: NIKON CORPORATION, TOKYO (JP)

(21) Appl. No.: 11/703,242

(22) Filed: Feb. 7, 2007

(30) Foreign Application Priority Data
Feb. 16, 2006 (JP) 2006-038955
Jan. 30, 2007 (JP) 2007-19194

(51) Int. Cl. G06K 9/00

(52) U.S. Cl. 382/167

(57) ABSTRACT

An electronic camera comprises an image generation unit that generates a plurality of images for red-eye detection based upon an image obtained by capturing an image of a subject with an image-capturing elements a setting unit that sets a specific mode among a plurality of modes related to electronic camera functions, a selection unit that selects a specific type of red-eye detection processing among a plurality of types of red-eye detection processing different from one another, based upon the mode set via the setting unit; and a red-eye detection unit that detects a red-eye area based upon the images for red-eye detection by executing the red-eye detection processing selected by the selection unit.

### INCORPORATION BY REFERENCE

The disclosures of the following priority applications are herein incorporated by reference:
Japanese Patent Application No. 2006-038955 filed Feb. 16, 2006
Japanese Patent Application No. 2007-019194 filed Jan. 30, 2007

### BACKGROUND OF THE INVENTION

1. Field of the Invention

The present invention relates to a red-eye correction function of a camera equipped with an electronic flash unit.

2. Description of Related Art

There are cameras known in the related art that execute red-eye detection processing by referencing a captured image. Japanese Laid Open Patent Publication No. 2005-167697 discloses a technology whereby the length of processing time is reduced by reducing the size of a captured image and executing red-eye detection processing on the reduced image.

### SUMMARY OF THE INVENTION

However, there is a problem in that since a single red-eye detection processing method is adopted regardless of whether the camera is engaged in a single-shot photographing operation or a continuous shooting operation, the red-eye detection and correction processing cannot be executed over the time period depending on the particular photographing conditions.

According to the first aspect of this invention, an electronic camera comprises an image generation unit that generates a plurality of red-eye detection images based upon an image obtained by capturing an image of a subject with an image-capturing element, a setting unit that sets a specific mode among a plurality of modes related to electronic camera functions, a selection unit that selects a specific type of red-eye detection processing among a plurality of types of red-eye detection processing different from one another, based upon the mode set via the setting unit; and a red-eye detection unit that detects a red-eye area based upon the red-eye detection image by executing the red-eye detection processing selected by the selection unit.

According to the second aspect of the invention, in the electronic camera according to the first aspect of the invention, it is preferred that different red-eye detection images are used in the different types of red-eye detection processing respectively.

According to the third aspect of the invention, in the electronic camera according to the second aspect of the invention, it is preferred that the plurality of red-eye detection images are different from one another with respect to levels of image accuracy.

According to the fourth aspect of the invention, in the electronic camera according to the second aspect of the invention, it is preferred that the plurality of red-eye detection images are constituted with different numbers of pixels respectively.

According to the fifth aspect of the invention, in the electronic camera according to any of the first through the fourth aspect of the invention, it is preferred that in one type of red-eye detection processing among the plurality of types of red-eye detection processing which are different from one another, red-eye detection is executed by using one red-eye detection image, whereas in another type of red-eye detection processing, red-eye detection is executed by using two red-eye detection images each different from the one red-eye detection image.

According to the sixth aspect of the invention, in the electronic camera according to any of the first through the forth aspect of the invention, it is preferred that the plurality of modes include a photographing mode and a reproduction mode; and the red-eye detection unit detects a red-eye area through first red-eye detection processing when the reproduction mode has been selected and detects a red-eye area through second red-eye detection processing when the photographing mode has been selected.

According to the seventh aspect of the invention, in the electronic camera according to the first aspect of the invention, it is preferred that the plurality of modes include a high-speed continuous shooting mode and a low-speed continuous shooting mode; and the red-eye detection unit detects a red-eye area through first red-eye detection processing when the low-speed continuous shooting mode has been selected and detects a red-eye area through second red-eye detection processing when the high-speed continuous shooting mode has been selected.

According to the eighth aspect of the invention, in the electronic camera according to the sixth or the seventh aspect of the invention, it is preferred that the image generation unit generates a first red-eye detection image with a superior image accuracy level and a second red-eye detection image with a lower level of image accuracy based upon the image obtained by capturing an image of the subject with the image-capturing element; and first red-eye detection image is used to detect the red-eye area the first red-eye detection processing, and the first and the second red-eye detection images are used to detect the red-eye area through the second red-eye detection processing.

According to the ninth aspect of the invention, in the electronic camera according to the eighth aspect of the invention, it is preferred that if a red-eye area cannot be detected in the second red-eye detection image, the first red-eye detection image is used to detect a red-eye area during the second red-eye detection processing.

According to the tenth aspect of the invention, in the electronic camera according to any of the sixth through the ninth aspect of the invention, it is preferred that limits are imposed with regard to lengths of processing time over which the plurality of types of red-eye detection processing different from one another are executed, and the limited length of processing time set for the second red-eye detection processing is smaller than the limited length of processing time set for the first red-eye detection processing.

According to the eleventh aspect of the invention, in the electronic camera according to the first aspect of the invention, it is preferred that the plurality of modes include a high-speed continuous shooting mode, a low-speed continuous shooting mode and a reproduction mode, the selection unit selects first red-eye detection processing when the high-speed continuous shooting mode has been selected via the setting unit, selects second red-eye detection processing when the low-speed continuous shooting mode has been selected via the setting unit and selects third red-eye detection processing when the reproduction mode has been selected via the setting unit; and the red-eye detection unit detects a red-eye area based upon the red-eye detection image by executing the red-eye detection processing having been selected by the selection unit.

According to the twelfth aspect of the invention, in the electronic camera according to the eleventh aspect of the invention, it is preferred that the image generation unit generates a first red-eye detection image with a lowest level of image accuracy, a second red-eye detection image ranging over a focus-match area in the captured image, which has a highest level of image accuracy, and a third red-eye detection image with an image accuracy level between the image accuracy levels of the first and the second red-eye detection image, all based upon the image obtained by capturing an image of the subject with the image-capturing element, the first red-eye detection image is used to detect the red-eye area through the first red-eye detection processing, the first and the second red-eye detection images are used to detect the red-eye area through the second red-eye detection processing; and the third and the second red-eye detection images are used to detect the red-eye area through the third red-eye detection processing.

According to the thirteenth aspect of the invention, in the electronic camera according to the twelfth aspect of the invention, it is preferred that the second red-eye detection image is used to detect a red-eye area if a red-eye area cannot be detected in the first red-eye detection image during the second red-eye detection processing; and the second red-eye detection image is used to detect a red-eye area if a red-eye area cannot be detected in the third red-eye detection image during the third red-eye detection processing.

According to the fourteenth aspect of the invention, in the electronic camera according to the twelfth or the thirteenth aspect of the invention, it is preferred that the first red-eye detection image is a display image generated by reducing an image for recording, which is obtained by capturing an image of the subject with the image-capturing element, and the third red-eye detection image is a red-eye detection image obtained by reducing the image for recording.

According to the fifteenth aspect of the invention, in the electronic camera according to any of the eleventh through the fourteenth aspect of the invention, it is preferred that limits are imposed with regard to length of processing time over which the first red-eye detection processing and the second red-eye detection processing are executed and the limited length of processing time set for the first red-eye detection processing is smaller than the limited length of processing time set for the second red-eye detection processing.

According to the sixteenth aspect of the invention, in the electronic camera according to any of the first through the fifteenth aspect of the invention, it is preferred that the red-eye detection unit includes a red-eye position detection unit that detects a position at which red-eye occurs based upon the red-eye detection images; and the electronic camera further comprises a processing unit that executes red-eye correction processing on the captured image based upon the position of the red-eye detected by the red-eye position detection unit.

### BRIEF DESCRIPTION OF THE DRAWINGS

FIG. 1 illustrates the essential structure adopted in an electronic still camera achieved in an embodiment of the present invention;

FIG. 2 is a block diagram of the control system in the electronic still camera achieved in the embodiment of the present invention;

FIG. 3 shows red-eye detection images used in the red-eye detection processing, with FIG. 3A showing a main image, FIG. 3B showing a reduced red-eye detection image and FIG. 3C showing a reduced display image;

FIG. 4 shows operational flows of the red-eye correction processing, with FIG. 4A showing the operational flow of the simplified red-eye correction processing, FIG. 4B showing the operational flow of the standard red-eye correction processing and FIG. 4C showing the operational flow of the high accuracy red-eye correction processing;

FIG. 5 presents a flowchart of the processing procedure through which the simplified red-eye correction processing is executed;

FIG. 6 presents a flowchart of the processing procedure through which the standard red-eye correction processing is executed;

FIG. 7 presents a flowchart of the processing procedure through which the high accuracy red-eye correction processing is executed;

FIG. 8 shows another mode of the operational flow that may be adopted in conjunction with red-eye correction processing; and

FIG. 9 illustrates surrounding image areas.

### DESCRIPTION OF PREFERRED EMBODIMENT

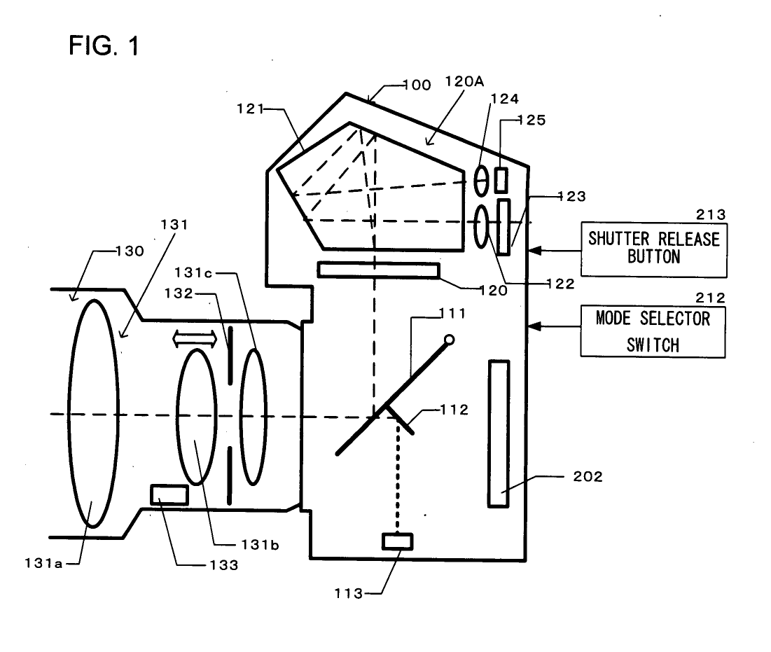

The following is an explanation of a single lens reflex electronic camera with a red-eye correction function achieved in an embodiment of the present invention, given in reference to drawings. FIG. 1 shows the essential structure adopted in the camera according to the present invention, which comprises a camera body 100, a viewfinder device 120A, a shutter release button 213 operated to issue a photographing instruction and a photographic lens 130. The photographic lens 130, which includes lenses 131a˜131c and an aperture 132, is detachably mounted at the camera body 100. The lens group 131b constitutes a focal point adjustment lens which is driven by a lens drive motor 133.

Subject light enters the camera body 100 after passing through the photographic lens 130 and prior to a full press operation of the shutter release button 213, the subject light having entered the camera body 100 is reflected at a quick return mirror 111 and forms an image at a viewfinder screen 120. The subject image is guided from a pentaprism 121 through a relay lens 122 to an eyepiece lens 123 and also the subject image at the pentaprism 121 is reformed via a photometering image reforming lens 124 onto the light receiving surface of a photometering element 125 constituted with an SPD, a CCD or the like. The brightness distribution of the subject undergoes photoelectric conversion at the photometering element 125.

In addition, prior to the full press operation of the shutter release button 123, the subject light having been transmitted through a semi-transmissive area of the quick return mirror 111 is reflected along the downward direction at a sub mirror 112 and thus enters a focal point detection device 113. The focal point detection device 113 may be, for instance, a phase-difference focal point detection device of the known art. In response to the full press operation of the shutter release button 213, the quick return mirror 111 swings upward and the subject light forms an image on an image-capturing element such as a CCD 202 via a shutter (not shown). The image-capturing element may be constituted with a photoelectric conversion element other than a CCD, such as a CMOS.

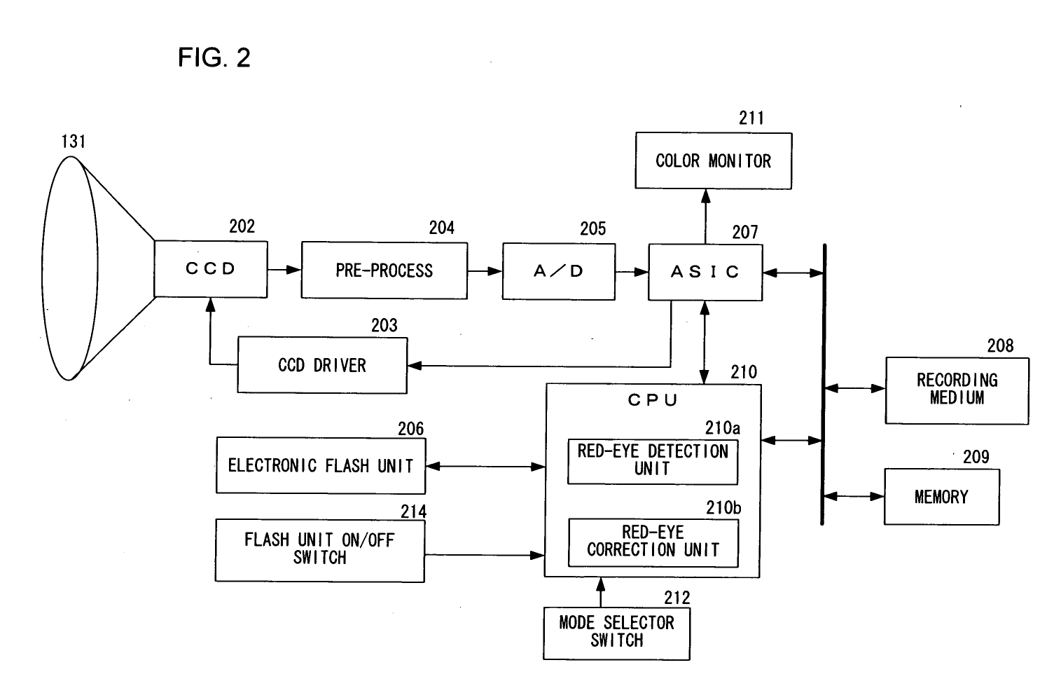

As shown in the block diagram in FIG. 2, analog image signals read out from the CCD 202 in response to a drive signal provided from a CCD driver 203 undergo signal amplification, black level adjustment and the like at a pre-process circuit 204. The analog image signals are then converted to digital image signals at an A/D converter 205 and the digital image signals resulting from the conversion are input to an ASIC 207. The ASIC 207 executes image processing such as γ correction and white balance adjustment on the digital image signals input thereto and outputs the digital image signals having undergone the image processing as image data. The image data are displayed at a color monitor 211 after the photographing operation and also are recorded into a memory 209 and a detachable non-volatile recording medium 208.

A mode selector switch 212 is operated to select a photographing mode, a reproduction mode, a setup mode or the like as the operating mode of the electronic camera. A high-speed continuous shooting mode, a low-speed continuous shooting mode, a single-shot photographing mode or the like can be selected as the photographing mode in which a photographing operation is executed in response to an operation of the shutter release button 213. In the reproduction mode, a CPU 210 reads out image data recorded in the recording medium 208 and displays a reproduced image generated by using the image data at the color monitor 211. In the setup mode, menu setting and the like are performed and red-eye correction processing, too, is set in the setup mode. A flash unit on/off switch 214 outputs an operation signal for allowing or disallowing light emission at the electronic flash unit 206 to the CPU 210.

The CPU 210 includes a red-eye detection unit 210a and a red-eye correction unit 210b as its functional units. The red-eye detection unit 210a, to which red-eye detection image data generated at the ASIC 207 are input, detects positional coordinates of an area where red-eye has occurred based upon the image data input thereto. The positional coordinate detection may be executed by using hue information, saturation information, brightness information or the like of the known art. Based upon the positional coordinates of the red-eye area detected via the red-eye detection unit 210a, the red-eye correction unit 210b corrects the red-eye portion of the photographic image data. The correction processing should be executed through a method of the known art by, for instance, substituting a color read from the surrounding area for the red-eye portion of the image data or by masking the red-eye area with a specific color, so as to ensure that the red-eye portion in the image data is rendered to be natural-looking.

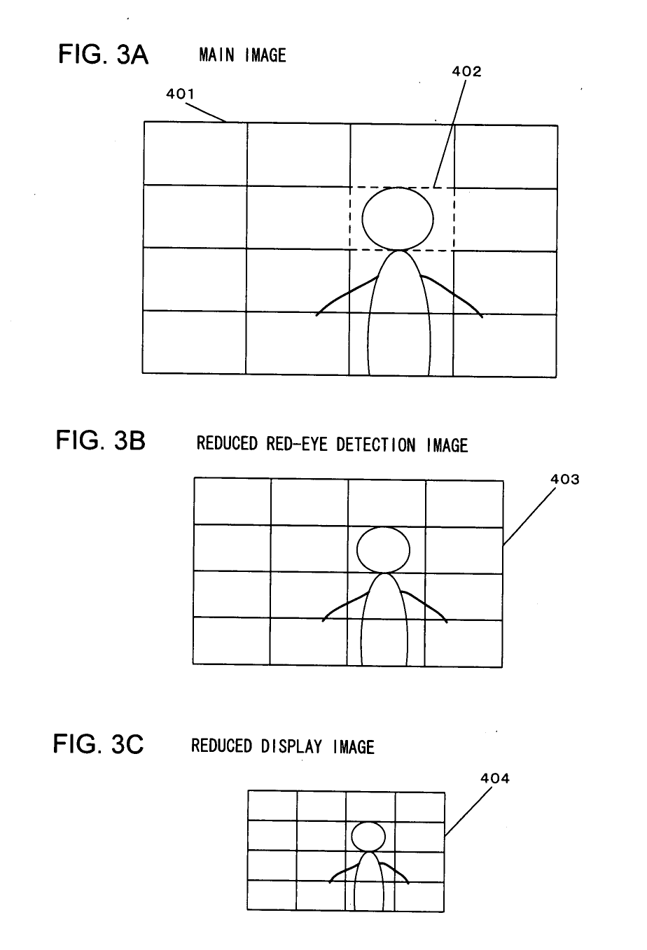

The red-eye detection images generated at the ASIC 207 are explained in reference to FIG. 3. FIG. 3A shows a main image 401. The main image 401 is generated by, for instance, executing white balance processing and the like on image signals output by the CCD 202 upon capturing an image. In the photographing mode, the main image 401 is obtained based upon image data having been JPEG-compressed and temporarily stored in the memory 209 or based upon image data having been JPEG-compressed and recorded in the recording medium 208. Alternatively, an image obtained based upon raw data may be used as the main image. While the data size of the main image may be, for instance, 2592×1944 dots, the main image may assume a data size other than this. An area 402 enclosed by the dotted lines in the main image 401 is a focus-match area and hereafter, the image within this area is to be referred to as a focus-match area image 402. Since a focus match is often achieved around the face of a person in an image the main photographic subject of which is a person, the red-eye detection unit 210a uses this focus-match area image 402 for detection of the positional coordinates of the red-eye area, as well as a reduced red-eye detection image 403 to be detailed later.

FIG. 3B shows the reduced red-eye detection image 403, the data size of which is smaller than that of the main image 401. The reduced red-eye detection image 403 is generated by the ASIC 207 through reducing processing combined with interpolation processing instead of simple reducing processing, so as to ensure that information indicating the color component corresponding to the red-eye area in the main image 401 does not become lost through the reduction processing. It is to be noted that while the data size of the reduced red-eye detection image 403 may be, for instance, 1024×768 dots, the reduced red-eye detection image may assume a data size other than this. However, the number of pixels constituting the reduced red-eye detection image should be smaller than the number of pixels constituting the focus-match area image 402. As described later, the reduced red-eye detection image 403 is used by the red-eye detection unit 210a for red-eye detection in the reproduction mode.

FIG. 3C shows a reduced display image 404. The reduced display image 404, generated by the ASIC 207, is displayed at the color monitor 211 in the reproduction mode. The reduced display image 404 is a VGA (video graphics array) image assuming a data size equivalent to 640×480 dots. The number of pixels constituting the reduced display image 404 is smaller than the number of pixels constituting the reduced red-eye detection image 403. As explained later, the reduced display image 404 is used by the red-eye detection unit 210a for red-eye detection in the high speed continuous shooting mode and the low-speed continuous shooting mode. As described above, the focus-match area image 402, the reduced red-eye detection image 403 and the reduced display image 404 are all used as red-eye detection images.

The images to be used by the red-eye detection unit 210a in the red-eye detection processing among the plurality of types of red-eye detection images described above are determined in correspondence to a specific mode among various photographing modes and the reproduction mode selected via the mode selector switch 212.

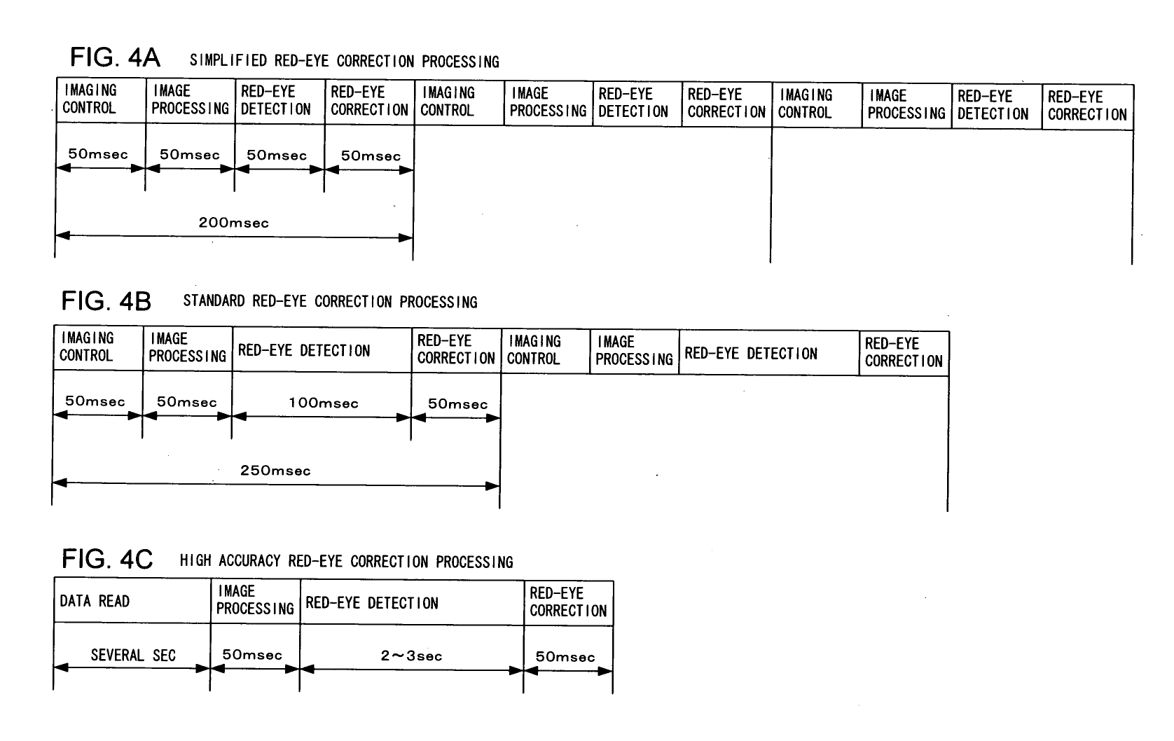

When the high-speed continuous shooting mode has been selected, the red-eye detection unit 210a executes red-eye detection by using the reduced display image 404. The processing executed by using the reduced display image is to be referred to as simplified red-eye correction processing. The operational flow of the simplified red-eye correction processing is shown in FIG. 4A. Image signals having been accumulated in the CCD 202 are read out under the imaging control and then the ASIC 207 generates the reduced display image 404 through the image processing. During the red-eye detection, the red-eye detection unit 210a detects the positional coordinates of the red-eye area by using the reduced display image 404. In the red-eye correction, the red-eye correction unit 210b converts the positional coordinates of the red-eye area having been detected through the red-eye detection to coordinates in the main image 401, executes the correction processing in the main image 401 as explained earlier, JPEG compresses the main image 401 and records the compressed main image.

The CPU 210 sets the total length of processing time per frame to 200 msec for the simplified red-eye correction processing. 50 msec is allocated as the processing time for each of the various phases of the processing, i.e., the imaging control, the image processing, the red-eye detection and the red-eye correction, while processing a single image frame. The length of time elapsing during the red-eye detection is counted with a timer, and if the positional coordinates of a red-eye area are not detected within the allocated 50 msec period, the red-eye detection unit 210a interrupts the detection and the red-eye correction unit 210b does not execute the red-eye correction processing. Then, the CPU 210 waits in standby until the total length of processing time, i.e., 200 msec, elapses, before photographing an image for the next frame. It is to be noted that the total length of processing time per frame does not need to be 200 msec and that the length of processing time allocated to each phase of the processing may be other than 50 msec.

When the low-speed continuous shooting mode or the single-shot photographing mode has been selected, the red-eye detection unit 210a executes red-eye detection by using the focus-match area image 402 and the reduced display image 404. The processing executed by using the focus-match area image 402 and the reduced display image 404 is to be referred to as standard red-eye correction processing. The operational flow of the standard red-eye correction processing is shown in FIG. 4B. While the contents of the various phases of processing are similar to those of the simplified red-eye correction processing explained earlier, the ASIC 207 generates the focus-match area image 402 and the reduced display image 404 based upon the main image 401 having been captured.

In the red-eye detection, the red-eye detection unit 210a detects the positional coordinates of a red-eye area as explained earlier by using the reduced display image 404. The red-eye detection unit 210a also detects the positional coordinates of the red-eye area by using the focus-match area image 402. Then, the red-eye detection unit 210a compares the red-eye area positional coordinates detected in the reduced display image 404 with the red-eye area positional coordinates detected in the focus-match area image 402 and makes a decision as to whether or not the two sets of red-eye area positional coordinates match each other. If the two sets of red-eye area positional coordinates match, the red-eye correction unit 210b executes the red-eye correction processing in the main image 401 based upon the red-eye area positional coordinates having been detected.

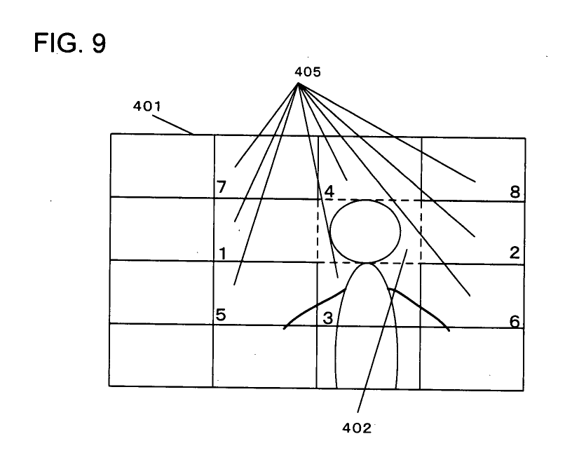

If the two sets of red-eye area positional coordinates do not match, the red-eye detection unit 210a detects the positional coordinates of a red-eye area by using one of surrounding area images 405 set around the focus-match area image 402. Then, the red-eye detection unit 210a makes a decision as to whether or not the red-eye area positional coordinates detected in the surrounding area image 405 match the red-eye area positional coordinates detected in the reduced display image 404. FIG. 9 shows the positional relationships between the surrounding area images 405 and the focus-match area image 402. The specific surrounding area image 405 to be used by the red-eye detection unit 210a for the positional coordinate detection should be selected by switching from one surrounding area image to another in the order indicated by the numerals assigned to the individual surrounding area images 405 in FIG. 9.

Since the processing does not need to be executed in the low-speed continuous shooting mode or the single-shot photographing mode as fast as in the high-speed continuous shooting mode, the CPU 210 sets the total length of processing time per frame to 250 msec. While processing the single frame, 50 msec is allocated to each of the following phases of the processing; imaging control, image processing and red-eye correction and 100 msec is allocated to the red-eye detection. As in the simplified red-eye correction processing, the length of time elapsing during the red-eye detection is counted with a timer. If the positional coordinates of a red-eye area are still not detected after the allocated 100 msec period elapses, the red-eye detection unit 210a interrupts the detection and the red-eye correction unit 210b does not execute the red-eye correction processing. Then, the CPU 210 waits in standby until the total length of processing time, i.e., 250 msec, elapses, as in the simplified red-eye correction processing. It is to be noted that the total length of processing time per frame does not need to be 250 msec and that the lengths of time allocated to the various processing phases and the red-eye detection may be other than 50 msec and 100 msec.

When the reproduction mode has been selected, the red-eye detection unit 210a executes red-eye detection by using the focus-match area image 402 and the reduced red-eye detection image 403. The processing executed by using the focus-match area image and the reduced red-eye detection image is to be referred to as high accuracy red-eye correction processing. FIG. 4C shows the operational flow of the high accuracy red-eye correction processing. Based upon image data read out from the recording medium 208 through the read processing, the ASIC 207 generates the focus-match area image 402 and the reduced red-eye detection image 403 as in the simplified red-eye correction processing and the standard red-eye correction processing explained earlier. Unlike in the simplified red-eye correction processing or the standard red-eye correction processing, the CPU 210 does not set a specific length of processing time per frame in the high accuracy red-eye correction processing. Namely, the red-eye detection unit 210a continuously executes the processing until the red-eye area is detected. In addition, if the red-eye area positional coordinates detected in the focus-match area image 402 and the red-eye area positional coordinates detected in the reduced red-eye detection image 403 do not match, the red-eye detection unit 210a detects the red-eye area positional coordinates by using one of the surrounding area images 405 set around the focus-match area image 402, as in the standard red-eye correction processing.

The procedures through which the three types of correction processing are executed are explained next.

Simplified Red-Eye Correction Processing

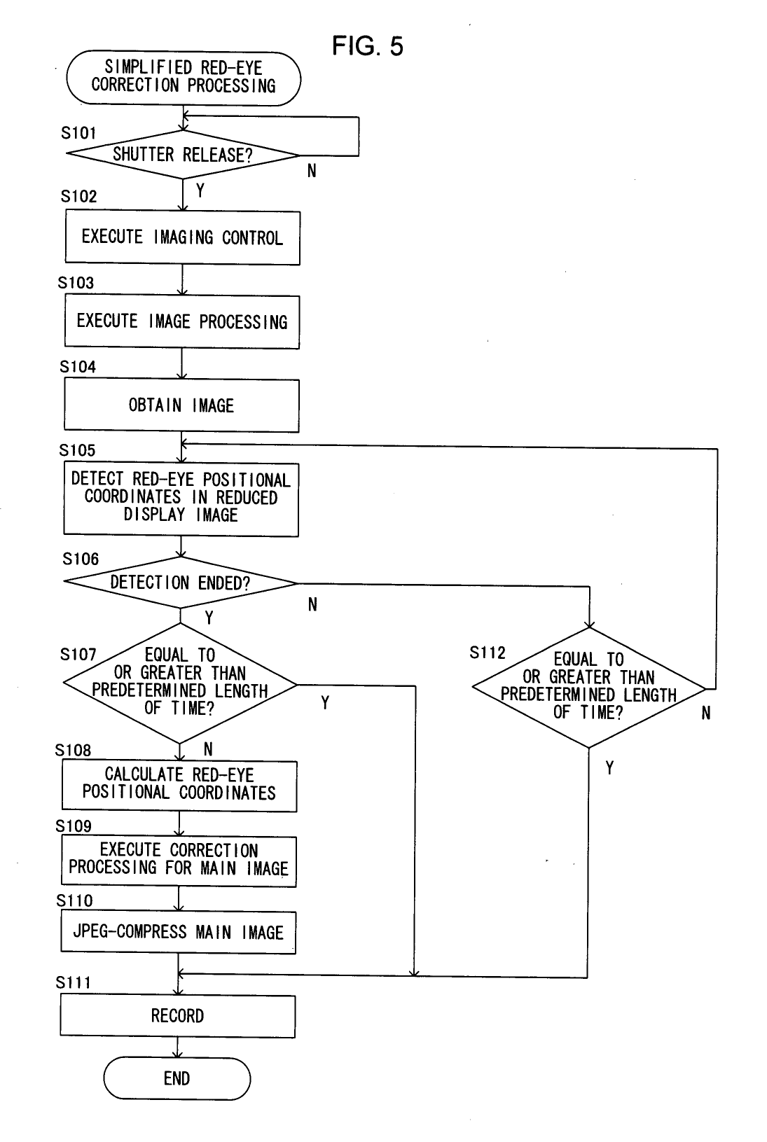

In reference to the flowchart presented in FIG. 5, the red-eye correction processing executed for an image photographed by the electronic camera set in the high-speed continuous shooting mode, i.e., the simplified red-eye correction processing, is explained. It is to be noted that the flowchart presented in FIG. 5 shows the procedure of the processing executed in conformance to a program executed by the CPU 210 in the electronic camera. The program, which is stored in the memory (not shown), is started up when the red-eye correction processing, the light emission at the electronic flash unit 206 and the high-speed continuous shooting mode are selected as photographing conditions.

In step S101, a decision is made as to whether or not the shutter release button 213 has been pressed down. If an affirmative decision is made, i.e., if it is decided that the shutter release button 213 has been depressed, the operation proceeds to step S102. If, on the other hand, a negative decision is made, i.e., if it is decided that the shutter release button 213 has not been depressed, the operation waits in standby until the shutter release button 213 is operated.

In step S102, image signals are read out from the CCD 202 via the CCD driver 203. Once the image signals having been read out are input to the ASIC 207, the operation proceeds to step S103. In step S103, an image generation processing instruction is issued to the ASIC 207. The ASIC 207 generates the main image 401 and the reduced display image 404 created based upon the main image 401 in response to the instruction. Once these images are generated, the operation proceeds to step S104.

In step S104, the image data of the main image 401 and the reduced display image 404 having been generated by the ASIC 207 are stored into the memory 209. Upon storing the image data of the two images, the operation proceeds to step S105. In step S105, detection of the positional coordinates of an area where a red-eye phenomenon has manifested in the reduced display image 404 is started, before the operation proceeds to step S106. It is to be noted that as the red-eye area positional coordinate detection starts, the timer is started up to start counting the length of time elapsing while the positional coordinate detection is in progress.

In step S106, a decision is made as to whether or not red-eye area positional coordinates have been detected. If an affirmative decision is made, i.e., if it is decided that the positional coordinates of a red-eye area have been detected, the operation proceeds to step S107. If, on the other hand, a negative decision is made, i.e., if it is decided that the positional coordinates of a red-eye area have not been detected, the operation proceeds to step S112.

In step S107, a decision is made as to whether or not the timer count value provided by the timer having started the time count in step S105, i.e., the length of time having elapsed while the red-eye area positional coordinate detection has been in progress, is equal to or greater than the predetermined length of time, 50 msec. If an affirmative decision is made, i.e., if it is decided that the red-eye area positional coordinate detection has been in progress for 50 msec or more, the red-eye area positional coordinate detection is interrupted and the operation skips to step S110 without executing the red-eye correction processing for the main image 401. If a negative decision is made in step S107, i.e., if it is decided that the length of time having elapsed while the red-eye area positional coordinate detection has been in progress is less than 50 msec, the operation proceeds to step S108. It is to be noted that once the decision-making in step S107 ends, the time count by the timer having been started in step S105 is stopped and the timer count value is reset to 0.

In step S108, the positional coordinates of the red-eye area in the main image 401 are calculated based upon the red-eye area positional coordinates detected in the reduced display image 404. Namely, since the number of pixels constituting the main image 401 is 2592×1944 dots and the number of pixels constituting the reduced display image 404 is 640×480 dots, the red-eye area coordinates detected in the reduced display image 404 are multiplied by 4.05 along the vertical and horizontal directions to determine the red-eye area positional coordinates in the main image 401. Once the red-eye area positional coordinates in the main image 401 are calculated, the operation proceeds to step S109.

In step S109, the red-eye correction processing is executed for the main image 401 and then the operation proceeds to step S110. In the red-eye correction processing, the red-eye area at the positional coordinates having been calculated in step S108 in the image data of the main image 401 stored in the memory 209 is corrected. The red-eye correction is executed by substituting a color read from the surrounding area for the red-eye portion of the image data or a specific color, as described earlier.

If, on the other hand, no red-eye area is detected through the red-eye area positional coordinate detection processing having been started in step S105 and a negative decision is made in step S106 accordingly, a decision is made in step S112 as to whether or not the timer count value at the timer having started the time count in step S105 indicates a value equal to or greater than 50 msec. If an affirmative decision is made, i.e., if it is decided that the red-eye area positional coordinate detection has been in progress for 50 msec or more, the red-eye area positional coordinate detection is interrupted and the operation skips to step S110 without executing the red-eye correction processing for the main image 401. In addition, the timer having been started in step S105 is stopped at this point and the timer count value is reset to 0. If a negative decision is made in step S112, i.e., if it is decided that the length of time having elapsed while the red-eye area positional coordinate detection has been in progress is less than 50 msec, the operation returns to step S105 to start the red-eye area positional coordinate detection again.

In step S110, the image data of the main image 401 having been temporarily stored into the memory 209 are JPEG-compressed, and then the operation proceeds to step S111. In step S111, the image data of the main image 401, having undergone the compression processing, are recorded into the recording medium 208.

Standard Red-Eye Correction Processing

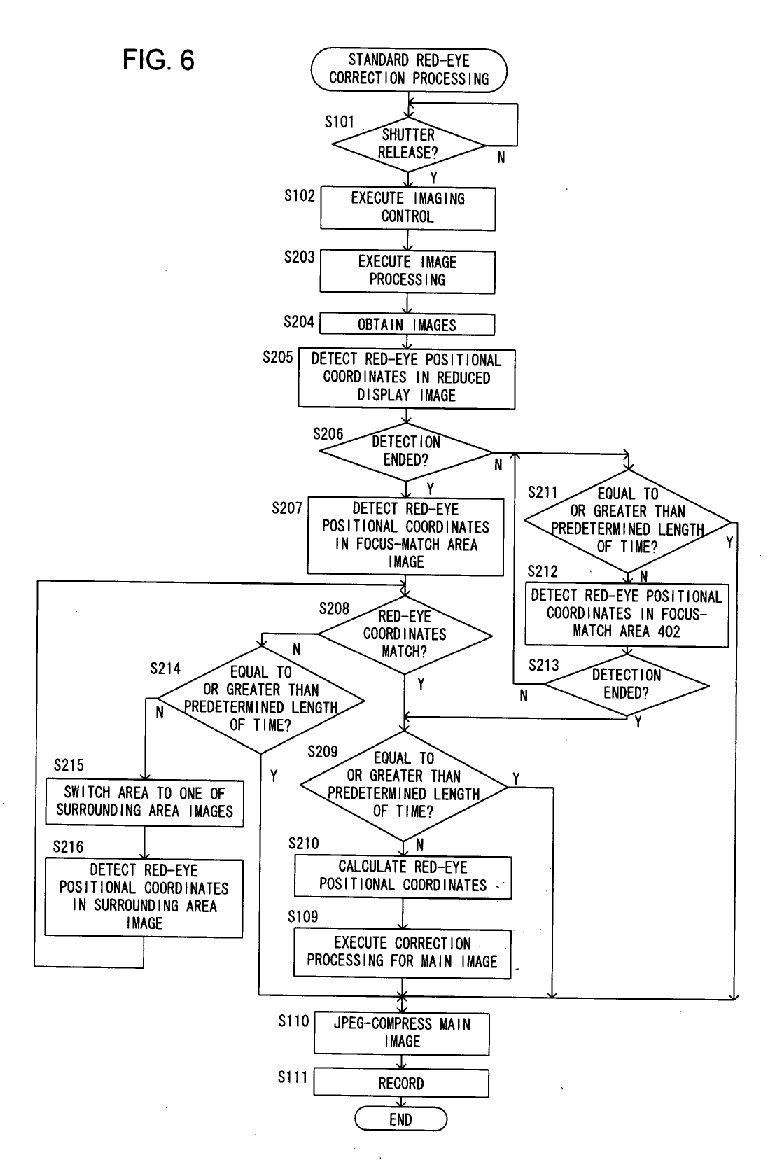

In reference to the flowchart presented in FIG. 6, the red-eye correction processing executed when the electronic camera is set in the low-speed continuous shooting mode or the single-shot photographing mode, i.e., the standard red-eye correction processing, is explained. As does the flowchart of the simplified red-eye correction processing, the flowchart presented in FIG. 6 shows the procedure of processing executed in conformance to a program executed by the CPU 210 in the electronic camera. The program, which is stored in the memory (not shown), is started up as the red-eye correction processing, light emission at the electronic flash unit 206 and the low-speed continuous shooting mode or the single-shot photographing mode are selected. In addition, the same step numbers are assigned to steps in which processing similar to that in the flowchart presented in FIG. 5 is executed and the following explanation focuses on differences from the procedure shown in the flowchart presented in FIG. 5.

In step S203, an image generation processing instruction is issued to the ASIC 207. The ASIC 207 generates the focus-match area image 402 and the reduced display image 404 created based upon the main image 401, as well as the main image 401 itself, in response to the instruction. Once these images are generated, the operation proceeds to step S204.

In step S204, the image data of the main image 401, the focus-match area image 402 and the reduced display image 404 having been generated by the ASIC 207 are stored into the memory 209. Upon storing these image data, the operation proceeds to step S205. In step S205, detection of the positional coordinates of an area where a red-eye phenomenon has manifested in the reduced display image 404 is started, before the operation proceeds to step S206. It is to be noted that as the red-eye area positional coordinate detection starts, the timer is started up to start counting the length of time elapsing while the positional coordinate detection is in progress.

In step S206, a decision is made as to whether or not red-eye area positional coordinates have been detected. If an affirmative decision is made, i.e., if it is decided that the positional coordinates of a red-eye area have been detected, the operation proceeds to step S207. If, on the other hand, a negative decision is made, i.e., if it is decided that the positional coordinates of a red-eye area have not been detected, the operation proceeds to step S211.

In step S207, the positional coordinates of an area in which the red-eye phenomenon has manifested in the focus-match area image 402 are detected and the operation proceeds to step S208. In step S208, a decision is made as to whether or not the red-eye area positional coordinates having been detected in the reduced display image 404 in step S206 match the red-eye area positional coordinates having been detected in the focus-match area image 402 in step S207. If an affirmative decision is made, i.e., if it is decided that the two sets of red-eye area positional coordinates match, the operation proceeds to step S209. If a negative decision is made, i.e., if it is decided that the two sets of red-eye area positional coordinates do not match, the operation proceeds to step S214.

If no red-eye positional coordinates are detected and a negative decision is made in step S206, a decision is made in step S211 as to whether or not the timer count value at the timer having started the time count in step 205 indicates a value equal to or greater than 100 msec. If an affirmative decision is made, i.e., if it is decided that 100 msec or more has elapsed, the red-eye area positional coordinate detection is interrupted and the operation skips to step S110 after stopping the timer having been started in step S205 and resetting the timer count value to 0, without executing the red-eye correction processing. If, on the other hand, a negative decision is made, i.e., if it is decided that the 100 msec period has not elapsed, the operation proceeds to step S212.

In step S212, red-eye area positional coordinate detection is executed based upon the focus-match area image 402 and then the operation proceeds to step S213. In step S213, a decision is made as to whether or not red-eye area positional coordinates have been detected. If an affirmative decision is made, i.e., if it is decided that the positional coordinates of a red-eye area have been detected, the operation proceeds to step S209. If, on the other hand, a negative decision is made, i.e., if it is decided that the positional coordinates of a red-eye area have not been detected, the operation returns to step S211.

If the two sets of red-eye area positional coordinates do not match and a negative decision is made in step S208 accordingly, a decision is made in step S214 as to whether or not the timer count value provided by the timer having started the time count in step S205, is equal to or greater than the predetermined length of time, 100 msec. If an affirmative decision is made, i.e., if it is decided that 100 msec or more has elapsed, the operation skips to step S110 after stopping the timer having been started in step S205 and resetting the timer count value to 0. If a negative decision is made in step S214, i.e., if it is decided that the length of time having elapsed while the red-eye area positional coordinate detection has been in progress is less than 100 msec, the operation proceeds to step S215.

In step S215, one of the surrounding area images 405 set around the focus-match area image 402 is selected to be used for the red-eye area positional coordinate detection. A specific surrounding area image may be selected by switching from one surrounding area image to another in a specific predetermined order indicated by, for instance, the numbers assigned to the individual surrounding area images 405 in FIG. 9. Once the processing in step S215 is competed, the operation proceeds to step S216.

In step S216, the positional coordinates of an area in which a red-eye phenomenon has manifested in the surrounding area image 405 are detected, and then the operation returns to step S208 to make a decision as to whether or not the red-eye area coordinates in the reduced display image 404 and the red-eye coordinates in the surrounding area image 405 match.

In step S209, a decision is made as to whether or not the timer count value provided by the timer having been started in step S205 indicates a value equal to or greater than the predetermined length of time 100 msec. If an affirmative decision is made, i.e., if it is decided that 100 msec or more has elapsed, the operation skips to step S110. If, on the other hand, a negative decision is made, i.e., if it is decided that the 100 msec period has not elapsed, the operation proceeds to step S210. It is to be noted that once the decision-making in step S209 ends, the time count on the timer having been started in step S205 is stopped and the timer count value is reset to 0.

In step S210, the positional coordinates of the red-eye area in the main image 401 are calculated based upon the red-eye area positional coordinates detected in one of; the focus-match area image 402, the reduced display image 404 and the surrounding area image 405. Namely, the positional coordinates in the main image 401 are calculated as follows based upon the red-eye area positional coordinates detected in the reduced display image 404. Since the number of pixels constituting the main image 401 is 2592×1944 dots and the number of pixels constituting the reduced display image 404 is 640×480 dots, the red-eye area coordinates detected in the reduced display image 404 are multiplied by 4.05 along the vertical and horizontal directions to determine the positional coordinates of the red-eye area in the main image 401. The positional coordinates of the red-eye area in the main image are calculated as follows based upon the red-eye area positional coordinates detected in the focus-match area image 402 or the surrounding area image 405. Since the focus-match area image 402 and the surrounding area image 405 are each an image cut out from the main image 401, the red-eye area positional coordinates in the focus-match area image 402 or the surrounding area image 405 only need to be correlated to coordinates within the corresponding area in the main image 401. Once the red-eye area positional coordinates in the main image 401 are calculated, the operation proceeds to step S109.

High Accuracy Red-Eye Correction Processing

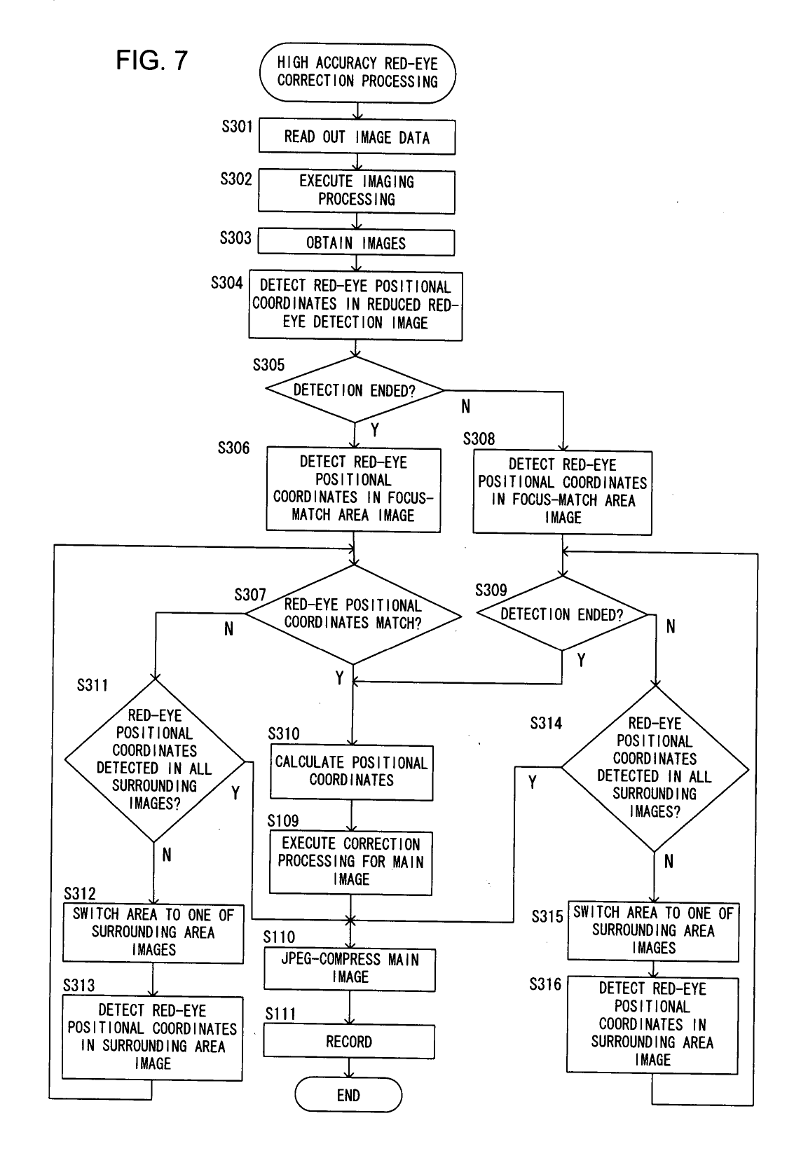

In reference to the flowchart presented in FIG. 7, the red-eye correction processing executed when the electronic camera is set in the reproduction mode, i.e., the high accuracy red-eye correction processing, is explained. The flowchart presented in FIG. 7 shows the procedure of processing executed in conformance to a program executed by the CPU 210 in the electronic camera. The program, which is stored in the memory, (not shown) is started up as the reproduction mode is selected. In addition, the same step numbers are assigned to steps in which processing similar to that in the flowchart presented in FIG. 5 is executed and the following explanation focuses on differences from the procedure shown in the flowchart presented in FIG. 5.

In step S301, the image data of the main image 401 recorded in the recording medium 208 are read out and are stored into the memory 209, before the operation proceeds to step S302. In step S302, an instruction for generating the focus-match area image 402 and the reduced red-eye detection image 403 based upon the image data of the main image 401 having been stored into the memory 209 is issued to the ASIC 207. Once the images are generated, the operation proceeds to step S303. It is assumed that information specifying the focus-match area is written in the image data of the main image 401 recorded in the recording medium 208.

In step S303, the image data of the focus-match area image 402 and the reduced red-eye detection image 403 are stored into the memory 209 and then the operation proceeds to step S304. In step S304, detection of the positional coordinates of an area where a red-eye phenomenon has manifested in the reduced red-eye detection image 403 is started and then the operation proceeds to step S305.

In step S305, a decision is made as to whether or not red-eye area positional coordinates have been detected. If an affirmative decision is made, i.e., if it is decided that the positional coordinates of a red-eye area have been detected, the operation proceeds to step S306. If, on the other hand, a negative decision is made, i.e., if it is decided that the positional coordinates of a red-eye area have not been detected, the operation proceeds to step S308.

In step S306, the positional coordinates of an area in which a red-eye phenomenon has manifested in the focus-match area image 402 are detected and the operation proceeds to step S307. In step S307, a decision is made as to whether or not the red-eye area positional coordinates having been detected in the reduced red-eye detection image 403 in step S304 match the red-eye area positional coordinates having been detected in the focus-match area image 402 in step S306. If an affirmative decision is made, i.e., if it is decided that the two sets of red-eye area positional coordinates match, the operation proceeds to step S310. If a negative decision is made, i.e., if it is decided that the two sets of red-eye area positional coordinates do not match, the operation proceeds to step S311.

If, on the other hand, no red-eye area positional coordinates are detected in the reduced red-eye detection image 403 and a negative decision is made in step S305 accordingly, red-eye area positional coordinate detection is executed by using the focus-match area image 402 in step S308, and then the operation proceeds to step S309. In step S309, a decision is made as to whether or not red-eye area positional coordinates have been detected. If an affirmative decision is made, i.e., if it is decided that the positional coordinates of a red-eye area have been detected, the operation proceeds to step S310. If, on the other hand, a negative decision is made, i.e., if it is decided that the positional coordinates of a red-eye area have not been detected, the operation proceeds to step S314.

If the red-eye area positional coordinates in the reduced red-eye detection image 403 and the red-eye area positional coordinates in the focus-match area image 402 do not match and a negative decision is made in step S307 accordingly, a decision is made as to whether or not the red-eye area positional coordinates detection has been performed in all the surrounding area images 405 as shown in FIG. 9 in step S311. If an affirmation decision is made, i.e., if it is decided that the red-eye area positional coordinates detection has been performed in all the surrounding area images 405, the operation proceeds to step S110. If a negative decision is made, i.e., if it is decided that there is the surrounding area image 405 in which the red-eye area positional detection has not been performed, the operation proceeds to step S312. If there is the surrounding area image 405 in which the red-eye area positional detection has not been performed and a negative decision is made in step S311 accordingly, the image used for the red-eye area positional coordinate detection is switched to one of the surrounding area images 405 set around the focus-match area image 402 in step S312. A specific surrounding area image 405 is selected in the predetermined order, as explained earlier. Once the processing in step S312 is completed, the operation proceeds to step S313.

In step S313, the positional coordinates of an area where a red-eye phenomenon has manifested in the surrounding area image 405 are detected and then, the operation returns to step S307 to make a decision again as to whether or not the red-eye area coordinates in the reduced red-eye detection image 403 and in the surrounding area image 405 match.

If no red-eye area positional coordinates are detected in the focus-match area image 402 and a negative decision is made in step S309 accordingly, the operation proceeds to step S314. The processing executed from step S314 (judgment of the red-eye detection processing in all the surrounding images) through step S316 (detecting red-eye area positional coordinates in the surrounding area image) are identical to those executed from step S311 (judgment of the red-eye detection processing in all the surrounding images) through step S313 (detecting red-eye area positional coordinates in the surrounding area image) respectively.

In step S310, the positional coordinates of the red-eye area in the main image 401 are calculated based upon the red-eye area positional coordinates detected in the focus-match area image 402, the reduced red-eye detection image 403 or the surrounding area image 405. Namely, the positional coordinates in the main image 401 are calculated as follows based upon the red-eye area positional coordinates detected in the reduced red-eye detection image 403. Since the number of pixels constituting the main image 401 is 2592×1944 dots and the number of pixels constituting the reduced red-eye detection image 403 is 1024×768 dots, the red-eye area coordinates detected in the reduced red-eye detection image 403 are multiplied by 2.53125 along the vertical and horizontal directions to determine the positional coordinates of the red-eye area in the main image 401. The positional coordinates of the red-eye area in the main image are calculated as follows based upon the red-eye area positional coordinates detected in the focus-match area image 402 or the surrounding area image 405. Since the focus-match area image 402 and the surrounding area image 405 are each an image sliced out from the main image 401, the red-eye area positional coordinates in the focus-match area image 402 or the surrounding area image 405 only need to be correlated to coordinates within the corresponding area in the main image 401. Once the red-eye area positional coordinates in the main image 401 are calculated, the operation proceeds to step S109 to execute the red-eye correction processing described earlier.

The following advantages are achieved in the embodiment described above.
(1) In correspondence to the specific current mode selected from a plurality of modes having been selected in the electronic camera, one type of processing among the simplified red-eye correction processing, the standard red-eye correction processing and the high accuracy a red-eye correction processing is selected and the red-eye detection is executed accordingly. Consequently, the red-eye area can be detected without compromising the accuracy, regardless of the mode having been selected in the electronic camera.
(2) Different types of red-eye detection processing are executed when the high-speed continuous shooting mode is selected as the photographing mode and when the low-speed continuous shooting mode or the single-shot photographing mode is selected as the photographing mode. Namely, in the high-speed continuous shooting mode, which requires high-speed processing, the simplified red-eye correction processing is executed, whereas the standard red-eye correction processing is executed in the low-speed continuous shooting mode and the single-shot photographing mode in which the processing does not need to be executed as fast as in the high-speed continuous shooting mode. As a result, red-eye correction can be completed within the optimal length of processing time, without compromising the red-eye detection accuracy.
(3) In the simplified red-eye correction processing, the red-eye detection unit 210a executes the red-eye detection by using the reduced display image 404 generated through reducing processing of the data constituting the main image 401. As a result, since the red-eye area positional coordinates are detected by using the reduced display image 404 constituted with a smaller number of pixels compared to the main image 401, the processing can be executed at high-speed as required in the high-speed continuous shooting mode.
(4) In the standard red-eye correction processing, the red-eye detection unit 210 executes the red-eye detection by using the focus-match area image 402 slicedcut out from the main image 401 and the reduced display image 404 generated through reducing processing of the data constituting the main unit 401. Namely, the red-eye area positional coordinate detection is first executed by using the reduced display image 404 constituted with a smaller number of pixels, and if no red-eye area coordinates are detected, the red-eye area positional coordinate detection is executed by using the focus-match area image 402 constituted with a larger number of pixels. As a result, the processing speed required in the low-speed continuous shooting mode or the single-shot photographing mode can be achieved without compromising the red-eye detection accuracy.
(5) If the red-eye detection unit 210a detects a red-eye area in the reduced display image 404 during the standard red-eye correction processing, the accuracy of the red-eye area positional coordinates having been detected is verified by using the focus-match area image 402 constituted with a greater number of pixels. Thus, the desired level of red-eye detection accuracy is assured since the red-eye correction processing is never executed on, for instance, lips erroneously recognized as a red-eye area.
(6) When the high-speed continuous shooting mode, the low-speed continuous shooting mode or the single-shot photographing mode has been selected in the camera, the red-eye detection processing by the red-eye detection unit 210a is interrupted after the red-eye detection processing has been in progress equal to or longer than a predetermined length of time. In addition, different settings are selected for the predetermined length of time in the simplified red-eye correction processing and in the standard red-eye correction processing. This means that since the red-eye correction processing is not executed indefinitely, and the photographing operation for the next frame is not delayed significantly, a good photographing opportunity does not need to be missed.
(7) When the reproduction mode has been selected in the camera, the high accuracy red-eye correction processing is executed. In the high accuracy red-eye correction processing, the red-eye detection unit 210a detects red-eye area positional coordinates by using the focus-match area image 402 sliced out from the main image 401 and the reduced red-eye detection image 403 generated through reducing processing of the image data constituting the main image 401. Since the reduced red-eye detection image 403 is constituted with a greater number of pixels than the reduced display image 404, a higher level of red-eye detection accuracy is assured.
(8) No limits are imposed with regard to the length of red-eye detection processing time in the high accuracy red-eye correction processing. This means that any red-eye phenomenon can be detected with a high level of accuracy in the reproduction mode.

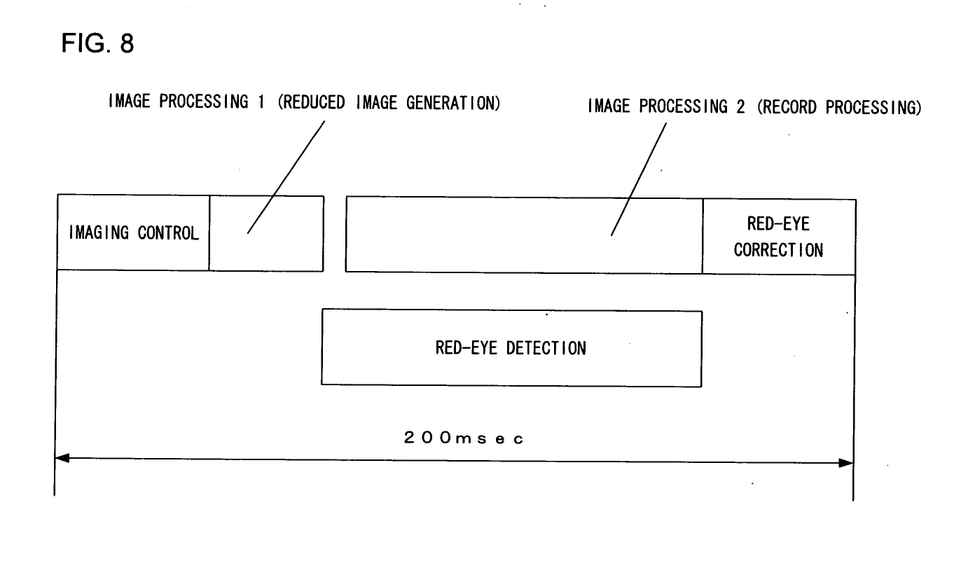

The embodiment described above allows for the following variations.
(1) In the simplified red-eye correction processing and the standard red-eye correction processing, the red-eye correction is executed for the main image 401 and the image processing is executed to generate image data for recording, only after the detection of red-eye area positional coordinates in the entire image area of the focus-match area image 402 or the reduced display image 404 is completed. However, the detection of red-eye area positional coordinates in the focus-match area image 402 or the reduced display image 404 and the image processing for generating the portion of the main image 401 to be recorded, which corresponds to the image area having been scanned, may be executed concurrently, as shown in FIG. 8. By concurrently executing the positional coordinate detection and the image processing, a greater length of time can be allocated to the red-eye area positional coordinate detection. Alternatively, the length of time allocated to the red-eye detection may remain unaltered and, in this case, the total length of processing time per frame can be reduced.
(2) While the time count for the length of time over which the red-eye detection processing remains in progress is started as the red-eye detection processing starts in the simplified red-eye correction processing and the standard red-eye correction processing in the explanation provided above, the time count may instead be started at the start of the imaging control. In the latter case, the predetermined length of time should be set in correspondence to the length of time to elapse between the imaging control start and the red-eye detection processing end and a decision with regard to a timeout should be made based upon this length of time.
(3) In the simplified red-eye correction processing and the standard red-eye correction processing, a time count may be executed for each of the various phases of processing, i.e., the imaging control, the image processing, the red-eye detection and the red-eye correction, and a decision with regard to a timeout may be made based upon a predetermined length of time set in correspondence to each processing phase. In such a case, each phase of processing can be interrupted if its processing time exceeds the corresponding length of time set for the particular processing phase.
(4) While an explanation is given above in reference to the embodiment on an example in which the focus-match area image 402 and the reduced display image 404 are used in the standard red-eye correction processing, the reduced red-eye detection image 403 and the reduced display image 404 may be used in the standard red-eye correction processing, instead.
(5) Different red-eye detection images or different red-eye detection processing methods may be used in the continuous shooting modes and in the reproduction mode. For instance, simplified red-eye correction processing may be executed by using the reduced display image 404 in the continuous shooting modes, whereas standard red-eye correction processing may be executed by using the reduced display image 404 and the focus-match area image 402 as red-eye detection images in the reproduction mode. Alternatively, simplified red-eye correction processing may be executed by using the reduced red-eye detection image 403 in the continuous shooting modes.
(6) Different red-eye detection images or different red-eye detection processing methods may be used in the continuous shooting modes and in the single-shot photographing mode. For instance, simplified red-eye correction processing may be executed by using the reduced display image 404 in the continuous shooting modes, whereas standard red-eye correction processing may be executed by using the reduced display image 404 and the focus-match area image 402 as red-eye detection images in the single-shot photographing mode. Alternatively, the reduced red-eye detection image 403 may be used in the continuous shooting modes, whereas standard red-eye correction processing may be executed in the single-shot photographing mode by using the reduced red-eye detection image 403 and the focus-match area image 402 as red-eye detection images.
(7) Different red-eye detection images or different red-eye detection processing methods may be used in the single-shot photographing mode and in the reproduction mode. For instance, simplified red-eye correction processing may be executed in the single-shot photographing mode by using the reduced display image 404, whereas high accuracy red-eye correction processing may be executed in the reproduction mode by using the reduced display image 404 and focus-match area image 402 as red-eye detection images or high accuracy red-eye correction processing may be executed in the reproduction mode by using the reduced red-eye detection image 403 and the focus-match area image 404 as red-eye detection images. Alternatively, standard red-eye correction processing may be executed in the single-shot photographing mode by using the reduced red-eye detection image 403 and the focus-match area image 402. It is to be noted that different red-eye detection images or different red-eye detection methods may be used in the photographing modes, which includes the single-shot photographing mode and the continuous shooting modes, and in the reproduction mode.

In various modes including the low-speed continuous shooting mode and the reproduction mode, at least two types of red-eye detection images with varying levels of image accuracy may be generated and if a red-eye area cannot be detected in the red-eye detection image with the lower level of image accuracy, red-eye detection may be executed by using the red-eye detection image with the higher or superior level of image accuracy so as to assure reliable red-eye detection.
(8) The focus-match area image 402 is used in the standard red-eye correction processing and the high accuracy red-eye correction processing in the expression provided above. Instead, a small image area in the main image 401, which corresponds to the red-eye area positional coordinates detected in the reduced display image 404 or the reduced red-eye detection image 403, may be used in place of the focus-match area image 402 for the red-eye detection.

While an explanation is given above in reference to the embodiment on an example in which the present invention is adopted in a camera that allows the use of exchangeable lenses, the present invention may be adopted in a camera with an integrated lens.

1. An electronic camera, comprising:
an image generation unit that generates a plurality of images for red-eye detection based upon an image obtained by capturing an image of a subject with an image-capturing element;
a setting unit that sets a specific mode among a plurality of modes related to electronic camera functions;
a selection unit that selects a specific type of red-eye detection processing among a plurality of types of red-eye detection processing different from one another, based upon the mode set via the setting unit; and
a red-eye detection unit that detects a red-eye area based upon the image for red-eye detection by executing the red-eye detection processing selected by the selection unit.

2. An electronic camera according to claim 1, wherein:
different images for red-eye detection are used in the different types of red-eye detection processing respectively.

3. An electronic camera according to claim 2, wherein:
the plurality of images for red-eye detection are different from one another with respect to levels of image accuracy.

4. An electronic camera according to claim 2, wherein:
the plurality of images for red-eye detection are constituted with different numbers of pixels respectively.

5. An electronic camera according to
claim 1, wherein: in one type of red-eye detection processing among the plurality of types of red-eye detection processing which are different from one another, red-eye detection is executed by using one image for red-eye detection, whereas in another type of red-eye detection processing, red-eye detection is executed by using two images for red-eye detection each different from the one image for red-eye detection image.

6. An electronic camera according to
claim 1, wherein: the plurality of modes include a photographing mode and a
reproduction mode; and the red-eye detection unit detects a red-eye area through first red-eye detection processing when the reproduction mode has been selected and detects a red-eye area through second red-eye detection processing when the photographing mode has been selected.

7. An electronic camera according to claim 1, wherein:
the plurality of modes include a high-speed continuous shooting mode and a low-speed continuous shooting mode; and
the red-eye detection unit detects a red-eye area through first red-eye detection processing when the low-speed continuous shooting mode has been selected and detects a red-eye area through second red-eye detection processing when the high-speed continuous shooting mode has been selected.

8. An electronic camera according to claim 6,
wherein: the image generation unit generates a first image for red-eye detection with a superior image accuracy level and a second image for red-eye detection with a lower level of image accuracy based upon the image obtained by capturing an image of the subject with the image-capturing element; and
the first image for red-eye detection is used to detect the red-eye area through the first red-eye detection processing, and the first and the second images for red-eye detection are used to detect the red-eye area through the second red-eye detection processing.

9. An electronic camera according to claim 8, wherein:
if a red-eye area cannot be detected in the second image for red-eye detection, the first image for red-eye detection is used to detect a red-eye area during the second red-eye detection processing.

10. An electronic camera according to
claim 6, wherein: limits are imposed with regard to lengths of processing time over which the plurality of types of red-eye detection processing different from one another are executed, and the limited length of processing time set for the second red-eye detection processing is smaller than the limited length of processing time set for the first red-eye detection processing.

11. An electronic camera according to claim 1, wherein:
the plurality of modes include a high-speed continuous shooting mode, a low-speed continuous shooting mode and a reproduction mode;
the selection unit selects first red-eye detection processing when the high-speed continuous shooting mode has been selected via the setting unit, selects second red-eye detection processing when the low-speed continuous shooting mode has been selected via the setting unit and selects third red-eye detection processing when the reproduction mode has been selected via the setting unit; and
the red-eye detection unit detects a red-eye area based upon the image for red-eye detection by executing the red-eye detection processing having been selected by the selection unit.

12. An electronic camera according to claim 11, wherein:
the image generation unit generates a first image for red-eye detection with a lowest level of image accuracy, a second image for red-eye detection ranging over a focus-match area in the captured image, which has a highest level of image accuracy, and a third image for red-eye detection with an image accuracy level between the image accuracy levels of the first and the second images for red-eye detection, all based upon the image obtained by capturing an image of the subject with the image-capturing element;
the first image for red-eye detection is used to detect the red-eye area through the first red-eye detection processing;
the first and the second images for red-eye detection are used to detect the red-eye area through the second red-eye detection processing; and
the third and the second images for red-eye detection are used to detect the red-eye area through the third red-eye detection processing.

13. An electronic camera according to claim 12, wherein:
the second image for red-eye detection is used to detect a red-eye area if a red-eye area cannot be detected in the first image for red-eye detection during the second red-eye detection processing; and
the second image for red-eye detection is used to detect a red-eye area if a red-eye area cannot be detected in the third image for red-eye detection during the third red-eye detection processing.

14. An electronic camera according to claim 12,
wherein: the first image for red-eye detection is a display image generated by reducing an image for recording, which is obtained by capturing an image of the subject with the image-capturing element, and the third image for red-eye detection is a red-eye detection image obtained by reducing the image for recording.

15. An electronic camera according to
claim 11, wherein: limits are imposed with regard to length of processing time over which the first red-eye detection processing and the second red-eye detection processing are executed, and the limited length of processing time set for the first red-eye detection processing is smaller than the limited length of processing time set for the second red-eye detection processing.

16. An electronic camera according to
claim 1, wherein: the red-eye detection unit includes a red-eye position detection unit that detects a position at which red-eye occurs based upon the red-eye images for detection; and
the electronic camera further comprises a processing unit that executes red-eye correction processing on the captured image based upon the position of the red-eye detected by the red-eye position detection unit.

17. An electronic camera according to claim 7, wherein:
the image generation unit generates a first image for red-eye detection with a superior image accuracy level and a second image for red-eye detection with a lower level of image accuracy based upon the image obtained by capturing an image of the subject with the image-capturing element; and
the first image for red-eye detection is used to detect the red-eye area through the first red-eye detection processing, and the first and the second images for red-eye detection are used to detect the red-eye area through the second red-eye detection processing.

18. An electronic camera according to claim 13, wherein: the first image for red-eye detection is a display image generated by reducing an image for recording, which is obtained by capturing an image of the subject with the image-capturing element, and the third image for red-eye detection is a red-eye detection image obtained by reducing the image for recording.
